(19) United States
(12) Patent Application Publication
(10) Pub. No.: US 2010/0260573 A1
(43) Pub. Date: Oct. 14, 2010

(54) UTILITY STRAP

(76) Inventors: Michael J. Gardner, Hudson, OH (US); Glenn A. Baker, Cleveland, OH (US); Gregory E. Williams, Minerva, OH (US)

Correspondence Address: Emerson, Thomson & Bennett, LLC, 1914 Akron-Peninsula Road, Akron, OH, 44313, US

(21) Appl. No.: 12/760,310

(22) Filed: Apr. 14, 2010

Related U.S. Application Data
(60) Provisional application No. 61/169,134, filed on Apr. 14, 2009.

(51) Int. Cl. F16B 39/00; A44B 99/00; F16L 3/08; B23P 19/02

(52) U.S. Cl. 411/81; 24/1; 248/74.1; 29/525

(57) ABSTRACT

A utility strap which may be used to retain utility lines may include a finger defining a receiving section wherein the receiving section is sized to hold utility lines; a tab extending from one end of the finger wherein the tab defines an attaching surface and the tab contains at least one aperture on the attaching surface; a bushing sized to fit into the at least one aperture and the bushing having a through hole sized to receive fasteners.

This application claims priority to U.S. Ser. No. 61/169,134, entitled STRAP WITH FASTENER, filed Apr. 14, 2009, which is incorporated herein by reference.

### I. BACKGROUND OF THE INVENTION

A. Field of Invention

This invention generally relates to methods and apparatuses for retaining utility lines and more specifically to methods and apparatuses concerning straps to retain utility lines.

B. Description of the Related Art

It is well known in the art to provide straps, clamps, clips or similar utility line holders to retain utility lines. Utility lines may include electrical cable, electrical lines, conduit, plumbing lines, and tubing. Typically the holders have a section formed to receive and retain the utility line and an attachment point to secure the holder to a structure during the installation. These holders are normally formed from one material.

Known holders use fasteners to secure the holder. The fastener is inserted through a hole or opening in the holder and then driven into the underlying installation surface. Typical fasteners include nails, screws, pins, bolts, or the like. The locations where holders need to be installed are often awkward to reach. One problem that exists with known holders is the difficulty of manipulating the holder, the utility line, and the fastener whole trying to install this combination in such awkward locations.

Known attempted solutions to this problem include partially inserting the fastener into the holder before the holder arrives at the installation location. For holders made from one material, this solution results in another set of problems. It is necessary to have a tight fit of the fastener into the holder in order to keep the fastener from falling out before installation. But sizing the opening or hole in the holder to obtain this tight fit can result in high forces to finish driving the fastener through the holder and into the installation surface. The high driving force may result in damage to the holder, to the utility line being installed, or the installation surface.

Known attempted solutions to problems with holders using preinstalled fasteners involve strengthening the holder by adding material or by forming critical areas in complex geometries. But this solution often results in an increased cost for the holder.

There remains a need for a utility holder that is more reliable, less expensive, and easier to install.

### II. SUMMARY

According to one embodiment of this invention, a utility strap may comprise a finger defining a receiving section wherein the receiving section is sized to hold utility lines; a tab extending from one end of the finger wherein the tab defines an attaching surface and the tab contains at least one aperture on the attaching surface; a bushing sized to fit into the at least one aperture and the bushing having a through hole sized to receive fasteners.

According to another embodiment of this invention, a utility strap may comprise a finger defining a receiving section wherein the receiving section is sized to hold utility lines; a first tab extending from one end of the finger wherein the fist tab defines an attaching surface and the first tab contains at least one aperture on the attaching surface; a first bushing sized to fit into the at least one aperture on the first tab and the bushing having a through hole sized to receive fasteners; a second tab extending from one end of the finger wherein the second tab defines an attaching surface and the second tab contains at least one aperture on the attaching surface; a second bushing sized to fit into the at least one aperture on the second tab and the bushing having a through hole sized to receive fasteners.

According to yet another embodiment of this invention, a method may comprise the steps of: (A) providing a utility strap comprising: a finger defining a receiving section wherein the receiving section is sized to hold utility lines; a tab extending from one end of the finger wherein the tab defines an attaching surface and the tab contains at least one aperture on the attaching surface; and, a bushing sized to fit into the at least one aperture and the bushing having a through hole sized to receive fasteners; (B) positioning the bushing such that the longitudinal axis of the bushing aligns with the longitudinal axis of the aperture; and, (C) applying force to the bushing resulting in the bushing being pressed into the aperture a substantial distance.

One advantage of this invention is that a utility strap can be relatively simple to manufacture and use.

Another advantage of this invention is that a utility strap can be made that will accommodate a variety of fasteners in an economical fashion.

Yet another advantage of this invention is that a utility strap can be made that is very reliable to install.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a utility strap in accordance with a first embodiment.

FIG. 2 is a perspective view of a utility strap in accordance with a second embodiment.

FIG. 3 is a top view showing an opening to receive a fastener where the ends of one slot are shaped in a curve.

FIG. 4 is a top view showing an opening to receive a fastener where the ends of the slots are substantially square.

FIG. 5 is a top view showing an opening to receive a fastener where ends of the slot are curved and joined to the slot walls by a linear section.

FIG. 6 is a cross sectional view of an opening to receive a fastener where the opening is an embossed countersunk hole.

FIG. 7 is a close-up perspective view of the opening of FIG. 6 with a fastener inserted.

FIG. 8 is a perspective view similar to FIG. 7 but from a distance.

FIG. 9 is a cross sectional view of an opening to receive a fastener where the opening is extruded from the surface.

FIG. 10 is a perspective view of the opening of FIG. 9 with a fastener inserted.

FIG. 11 is a perspective view of an opening to receive a fastener where the opening is an impacted countersunk hole.

FIG. 12 is a perspective view of the opening of FIG. 1 with a fastener inserted.

FIG. 13 is a perspective view of an improved fastener used with the invention.

FIG. 14 is a perspective view of an alternate design utility strap.

FIG. 15 is a perspective view of an alternate design utility strap.

### IV. DETAILED DESCRIPTION

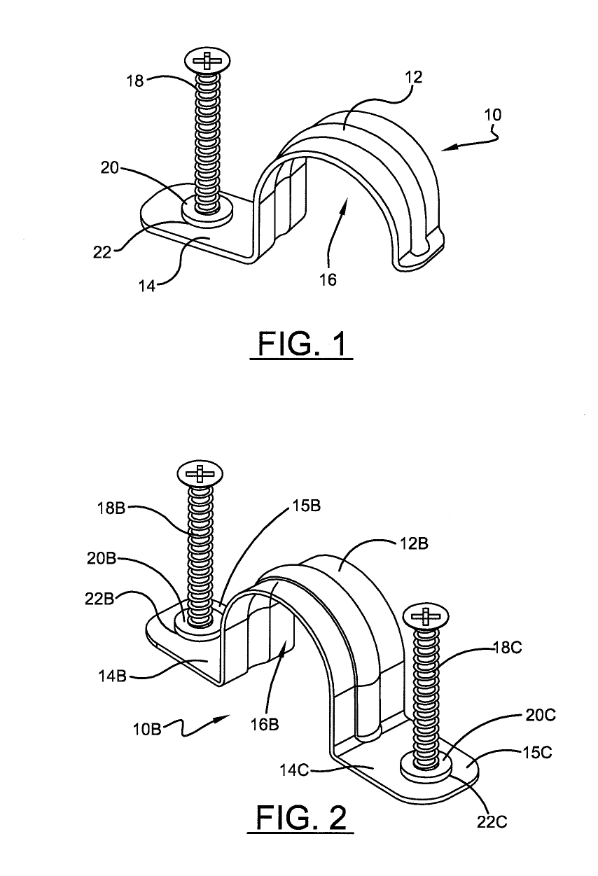

Referring now to the drawings wherein the showings are for purposes of illustrating embodiments of the invention only and not for purposes of limiting the same, and wherein like reference numerals are understood to refer to like components, FIG. 1 shows a utility strap 10 that may include a finger 12 defining a receiving section 16 wherein the receiving section 16 may be sized to hold utility lines; a tab 14 extending from one end of the finger 12 wherein the tab 14 may define an attaching surface and the tab 14 may contain at least one aperture 22 on the attaching surface; and, a bushing 20 may sized to fit into the at least one aperture 22 and the bushing 20 may have a through hole sized to receive fasteners 18.

With reference now to FIG. 2, a utility strap 10B is shown that may include a finger 12B defining a receiving section 16B wherein the receiving section 16B may be sized to hold associated utility lines (not shown). A first tab 14B extends from one end of the finger 12B wherein the first tab 14B may define an attaching surface 15B. The first tab 14B may contain at least one aperture 22B on the attaching surface; a first bushing 20B may be sized to fit into the at least one aperture 22B on the first tab 14B. The bushing 20B may have a through hole sized to receive a fastener 18B. A second tab 14C extending from one end of the finger 12B wherein the second tab 14C may define an attaching surface 15C and the second tab 14C may contain at least one aperture 22C on the attaching surface; and, a second bushing 20C may sized be to fit into the at least one aperture 22C on the second tab 14C and the bushing 20C may have a through hole sized to receive fasteners 18C.

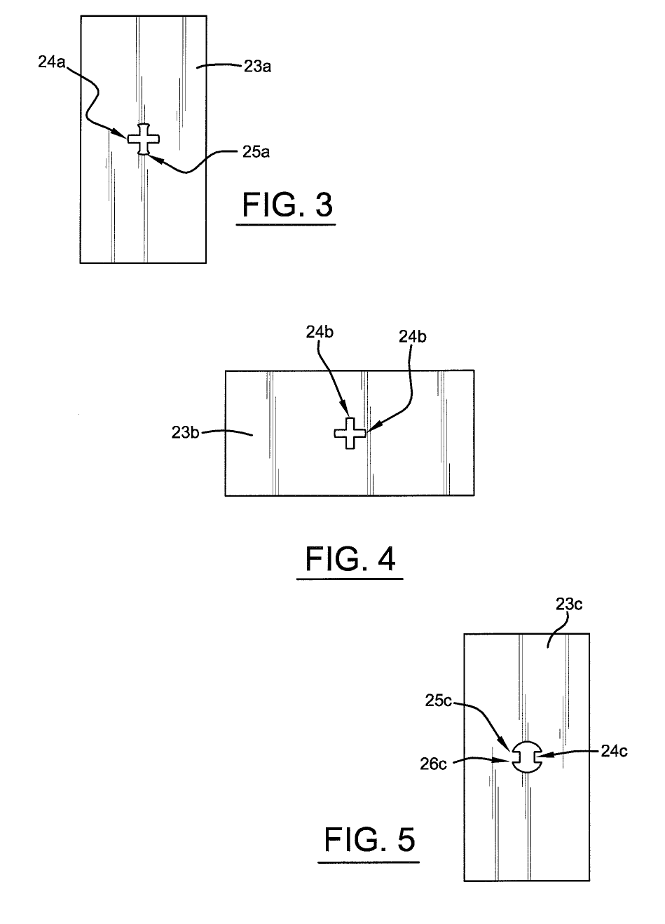

With reference now to FIG. 3, a profile of an opening 23a to receive a fastener is shown. The opening may be formed by two intersecting slots wherein the slots may be at a nonzero angle relative to each other. The ends of the first slot 24a may form a plane and may be perpendicular to the first slot walls. The ends of the second slot 25a may be curved and may joined to the second slot walls by a curved section.

With reference now to FIG. 4, FIG. 4 shows a profile of an opening 23b to receive a fastener. The opening may be formed by two intersecting slots wherein the slots 24b may be at a nonzero angle relative to each other. The ends of the each slot may be planar and may be perpendicular to the first slot walls.

With reference now to FIG. 5, FIG. 5 shows a profile of an opening 23c to receive a fastener. The opening may be formed by a slot 24c wherein the ends of the slot may be curved 25c and may joined to the slot walls by a linear section 26c.

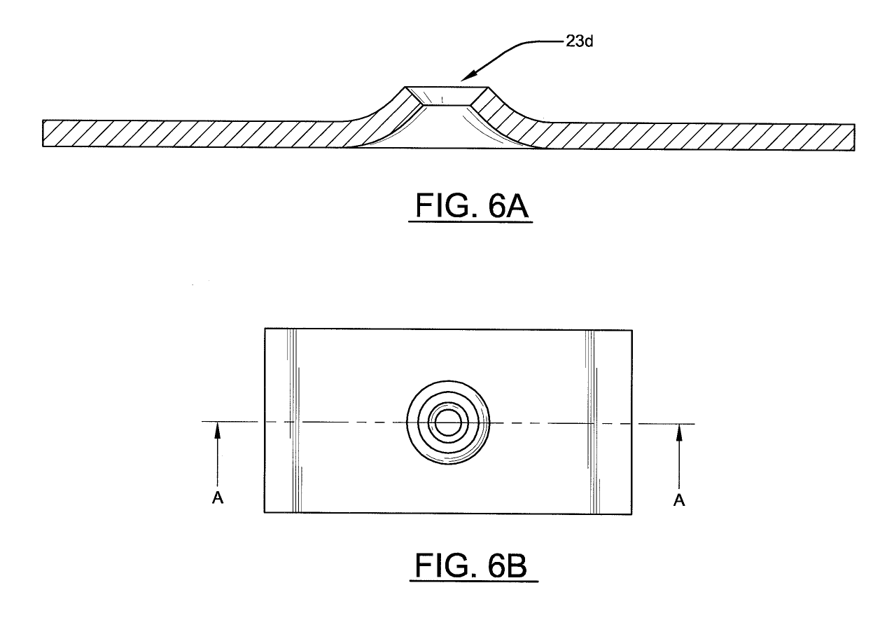

With reference now to FIG. 6, FIG. 6 shows a profile of an opening 23d to receive a fastener. The opening may be raised above the surrounding surface and may be connected to the surface by a section which may slope at a nonzero angle. The intersection of the nonzero angled section and the surrounding surface may contain a radius to blend the two regions. FIGS. 6A and 6B provide alternate views of the subject.

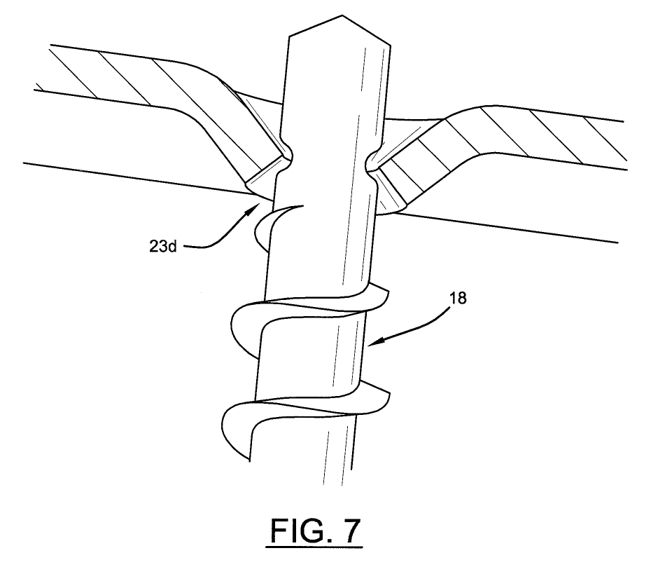

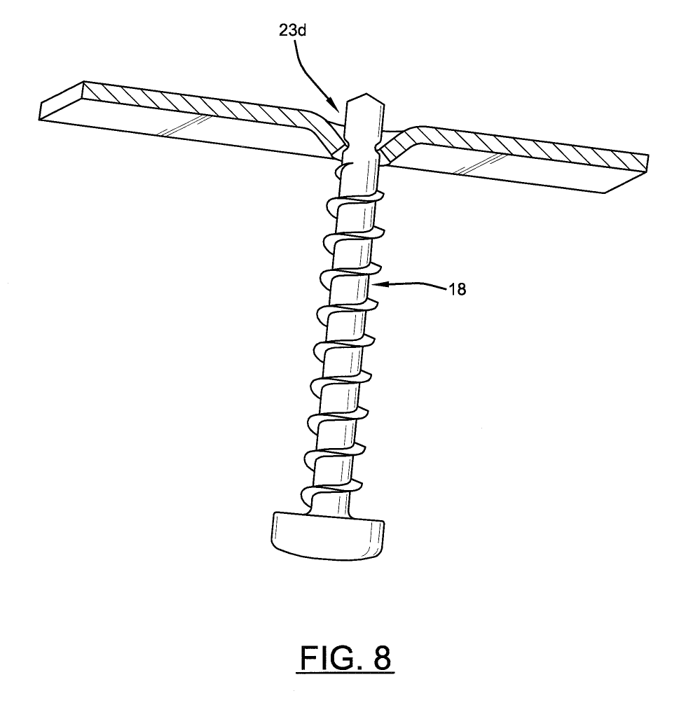

With reference now to FIGS. 7-8, FIGS. 7 and 8 show a fastener 18 inserted into the opening 23d of the profile shown in FIG. 6.

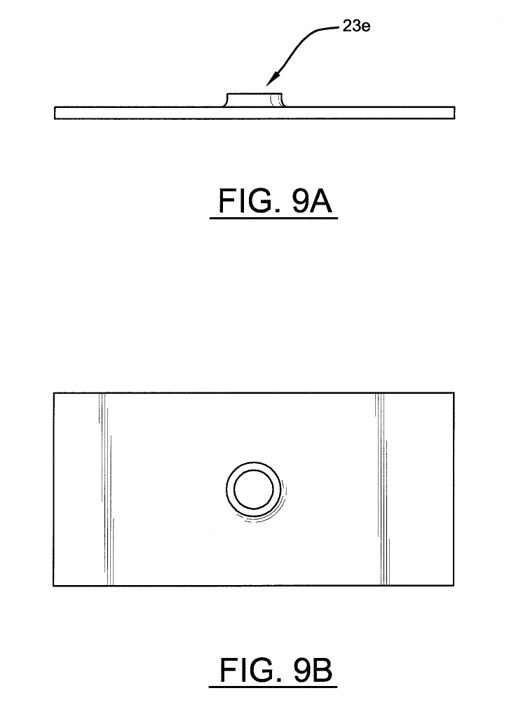

With reference now to FIG. 9, FIG. 9 shows a profile of an opening 23e to receive a fastener. The opening may be raised above the surrounding surface and may be connected to the surface by a section which may be curved in the shape of a first radius. The intersection of the curved section and the surrounding surface may contain a second radius to blend the two regions. FIGS. 9A and 9B provide alternate views of the subject.

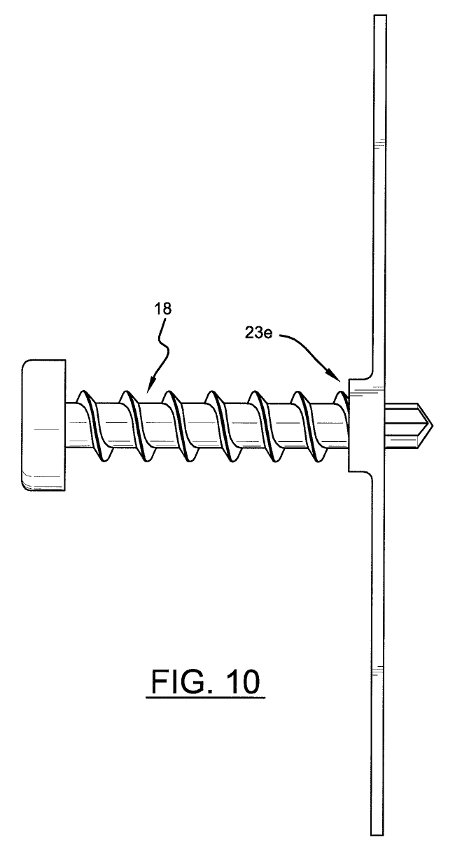

With reference now to FIG. 10, FIG. 10 shows a fastener 18 inserted into the opening 23e of the profile shown in FIG. 9.

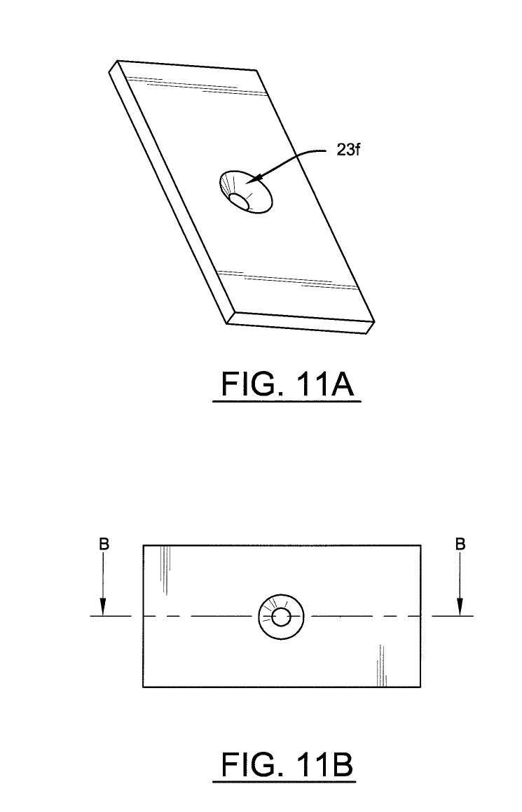

With reference now to FIG. 11, FIG. 11 shows a profile of an opening 23f to receive a fastener wherein the opening profile may be a frusto-conical shape.

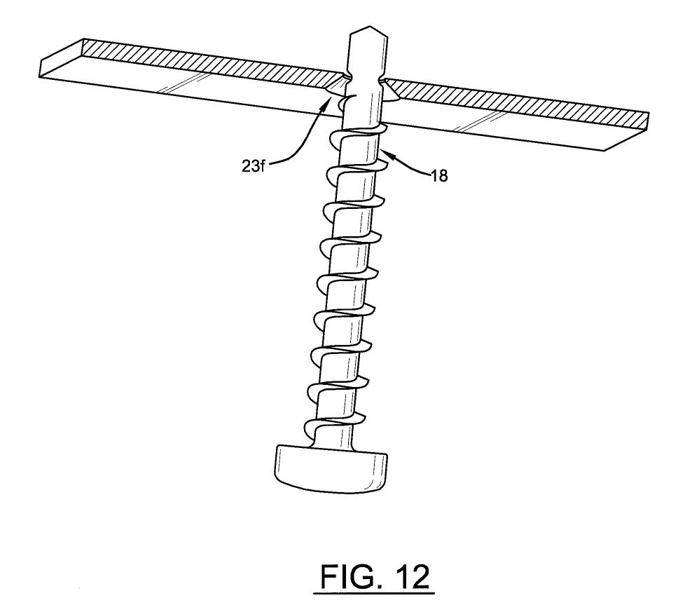

With reference now to FIG. 12, FIG. 12 shows a fastener 18 inserted into the opening 23f of the profile shown in FIG. 11. FIGS. 11A and 11B provide alternate views of the subject.

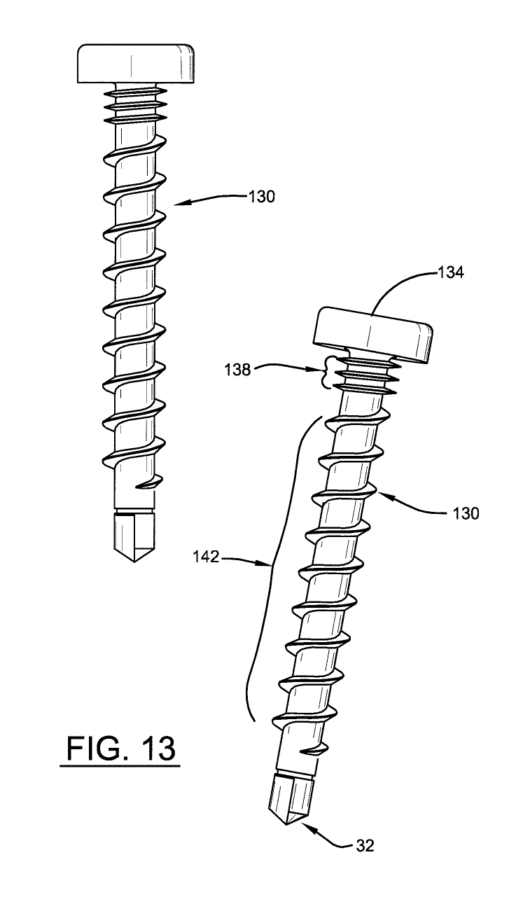

With reference now to FIG. 13, another embodiment is shown. The screw 130 shown incorporates features that are intended to allow use in a variety of materials. The smaller drill point 132 that is nearly equal to the minor diameter is to allow use in wood. Self-drilling screws, sometimes referred to as “SDS” screws remove excessive material, thus reducing holding power. The larger ratio of major diameter to minor diameter adds to the holding power. The fine pitch 138 under the head 134 is to allow for improved holding power in thin sheet metal. The increased pitch 142 with a small included angle on the threadform is to allow for improved thread forming in a variety of materials. The invention can include serrations and cutting features on leading threads. These may be helpful for use with some materials, along with possibly Trilobular or quad thread form. The groove shown is to allow the screw to be captured.

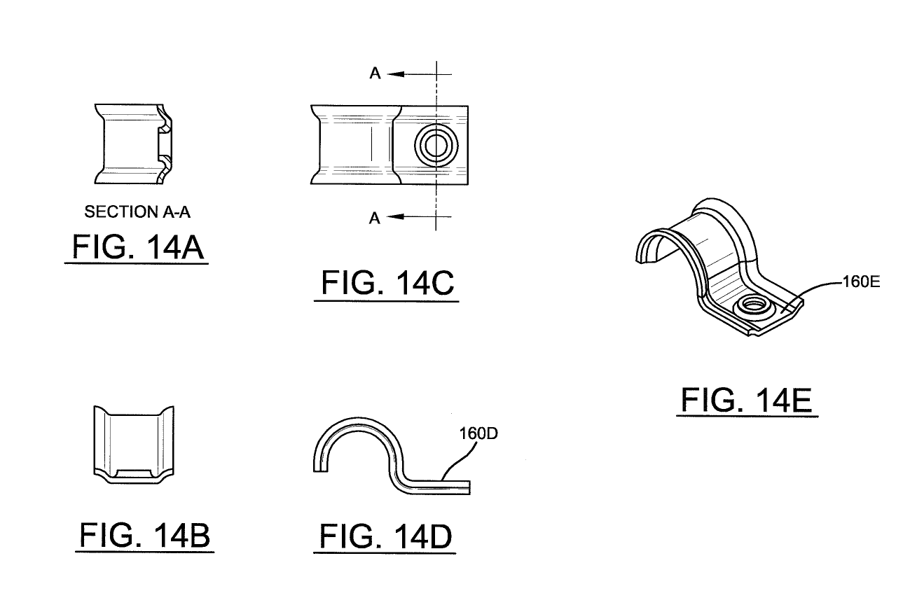

With reference now to FIG. 14, and the included FIGS. 14A through 14E, another embodiment is shown. The detail of embossed counter sink may vary. It may be an impacted countersink, or a modified extruded hole. It may vary based on material thickness. What is shown here is a feature to increase stiffness buy use of outside flanges 160D and 160E. This particular style may require development of improved or modified stamping art. Another embodiment features the mounting hole centerline located at a distance from the straps clamping radius (based on conduit size) so that the head of the fastener will create an interference where the strap begins to bend, stopping or limiting the deflection of strap that would allow the conduit to loosen or fall out.

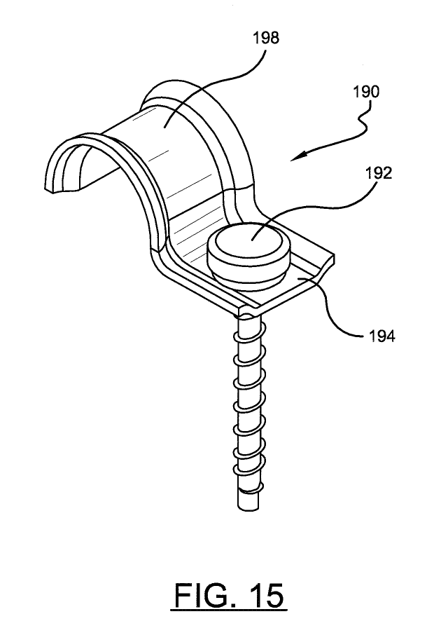

With reference now to FIG. 15, another embodiment is shown. Shown is an alternate style flange 190 that will improve stiffness. It also highlights the concept of creating an interference of the screw head 192 with the clamping area 194 of the strap 198. This feature may be created by location of the centerlines of clamping radii of strap and the mounting hole centerline, or the size of the fastener head, or a washer type feature, either integral to the fastener or not, or any combination of these.

With reference to the Figures, other aspects of the invention of a utility strap with an integral screw include the problem of excessive bending of one hole strap. One solution is increasing material thickness. Others include moving screw and hole securing point closer to bend to reduce deflection when load is applied. Another is adding gussets to bend to increase stiffness. Another is changing steel properties (strength and hardness) to reduce bend.

Further, to solve the requirement of having one screw to attach to multiple structure materials the invention includes a combination “3-stage” screw. Stage 1 is for metal and includes a drill lip for metallic materials to remove material, create a hole and penetrate the metal. Stage 2 is for wood and masonry and includes course threads with sharp thread angle for an aggressive bite into wood and masonry. Stage 3 is also for metal and features the last −0.15″ under the head having a fine pitch thread to secure the screw well into thin metal. The screw must be of sufficient hardness to (1) penetrate masonry and (2) not be dulled in the process. It is important for the threads to retain their shape and sharpness so they can bite securely once the screw reaches its final depth. Currently available commercial screws do not have these properties and either become dull in masonry applications or do not bite into sheet metal.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A utility strap comprising:
a finger defining a receiving section wherein the receiving section is sized to hold utility lines;
a tab extending from one end of the finger wherein the tab defines an attaching surface and the tab contains at least one aperture on the attaching surface; and,
a bushing sized to fit into the at least one aperture and the bushing having a through hole sized to receive fasteners.

2. The utility strap of claim 1 further comprising:
a fastener inserted into bushing.

3. The utility strap of claim 1 wherein:
the finger is formed from plastic; and
the tab is formed from plastic.

4. The utility strap of claim 3 wherein the finger and the tab are formed by a plastic molding process.

5. The utility strap of claim 1 wherein:
the finger is formed from metal; and
the tab is formed from metal.

6. The utility strap of claim 5 wherein the finger and the tab are formed by a metal stamping process.

7. The utility strap of claim 1 wherein the receiving section is sized to hold electrical conduit.

8. The utility strap of claim 1 wherein the receiving section is sized to hold electrical cable.

9. The utility strap of claim 1 wherein the receiving section is sized to hold plumbing lines.

10. The utility strap of claim 1 wherein the receiving section is sized to hold HVAC lines.

11. The utility strap of claim 1 wherein the bushing is formed from metal.

12. The utility strap of claim 1 wherein the bushing is formed from plastic.

13. The utility strap of claim 1 wherein the bushing is formed during a separate manufacturing process from the process that forms the finger.

14. The utility strap of claim 1 wherein the bushing and the finger are integrally formed during the same manufacturing process.

15. A utility strap comprising:
a finger defining a receiving section wherein the receiving section is sized to hold utility lines;
a first tab extending from one end of the finger wherein the fist tab defines an attaching surface and the first tab contains at least one aperture on the attaching surface;
a first bushing sized to fit into the at least one aperture on the first tab and the bushing having a through hole sized to receive fasteners;
a second tab extending from one end of the finger wherein the second tab defines an attaching surface and the second tab contains at least one aperture on the attaching surface; and,
a second bushing sized to fit into the at least one aperture on the second tab and the bushing having a through hole sized to receive fasteners.

16. The utility strap of claim 15 further comprising:
a first fastener inserted into the first bushing;
a second fastener inserted into the second bushing.

17. The utility strap of claim 16 further wherein the first and second fasteners are dual function wood/metal screws.

18. The utility strap of claim 16 further wherein the first tab contains one aperture and the second tab contains one aperture.

19. The utility strap of claim 16 further wherein the first tab contains two apertures and the second tab contains two apertures.

20. The utility strap of claim 16 further wherein the first and second fasteners are masonry screws.

21. A method comprising the steps of:
(A) providing a utility strap comprising: a finger defining a receiving section wherein the receiving section is sized to hold utility lines; a tab extending from one end of the finger wherein the tab defines an attaching surface and the tab contains at least one aperture on the attaching surface; and, a bushing sized to fit into the at least one aperture and the bushing having a through hole sized to receive fasteners;
(B) positioning the bushing such that the longitudinal axis of the bushing aligns with the longitudinal axis of the aperture; and,
(C) applying force to the bushing resulting in the bushing being pressed into the aperture a substantial distance.

22. A method of manufacturing a utility strap, the method comprising the steps of:
forming a finger, the figure having a receiving section and a tab, and the tab contains at least one aperture;
providing a bushing sized to fit into the aperture, the bushing having a through hole sized to receive fasteners;
positioning the bushing such that the longitudinal axis of the bushing aligns with the longitudinal axis of the aperture; and,
applying force to the bushing resulting in the bushing being pressed into the aperture a desired distance.

23. The method of claim 22 further comprising the step of:
positioning a fastener such that the longitudinal axis of the fastener aligns with the longitudinal axis of the aperture; and,
applying force to the fastener resulting in the fastener being pressed into the aperture a desired distance.
